(19) United States
(12) Patent Application Publication
(10) Pub. No.: US 2010/0172235 A1
(43) Pub. Date: Jul. 8, 2010

(54) SYSTEM AND METHOD FOR INITIALIZATION OF A SCRAMBLING SEQUENCE FOR A DOWNLINK REFERENCE SIGNAL

(75) Inventors: Lingjia Liu, Plano, TX (US); Jianzhong Zhang, Irving, TX (US); Yingyang Li, Plano, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/623,944

(22) Filed: Nov. 23, 2009

Related U.S. Application Data
(60) Provisional application No. 61/204,380, filed on Jan. 6, 2009.

(51) Int. Cl. H04J 11/00; H04W 72/00

(52) U.S. Cl. 370/208; 370/329

(57) ABSTRACT

A system and method for initialing a scrambling sequence for a downlink reference signal in a Long Term Evolution-Advanced (LTE-A) system. The system and method include initializing at the start of a radio frame, a scrambling sequence generator that initializes a seed of a scrambling sequence for downlink cell-specific reference signals for the LTE-A component carriers. The initialization seed is based on the component carrier ID. The system and method can transmit the reference signal in filler bands located between at least two component carriers in the LTE-A system.

### CROSS-REFERENCE TO RELATED APPLICATION(S) AND CLAIM OF PRIORITY

The present application is related to U.S. Provisional Patent No. 61/204,380, filed Jan. 6, 2009, entitled “INITIATION OF THE SCRAMBLING SEQUENCE FOR DOWNLINE REFERENCE SIGNAL”. Provisional Patent No. 61/204,380 is assigned to the assignee of the present application and is hereby incorporated by reference into the present application as if fully set forth herein. The present application hereby claims priority under 35 U.S.C. §119(e) to U.S. Provisional Patent No. 61/204,380.

### TECHNICAL FIELD OF THE INVENTION

The present application relates generally to wireless communications and, more specifically, to reference signal generation in wireless communications networks.

### BACKGROUND OF THE INVENTION

The Third Generation Partnership Project (3GPP) is a collaboration between groups of telecommunications associations, to make a globally applicable third generation (3G) mobile phone system specification within the scope of the International Mobile Telecommunications-2000 project of the International Telecommunication Union. Within 3GPP, Long Term Evolution (LTE) is a project within 3GPP to improve the Universal Mobile Telecommunications System (UMTS) mobile phone standard to cope with future technology advancements. The LTE physical layer is based on Orthogonal Frequency Division Multiplexing scheme (OFDM) to meet the targets of high data rate and improved spectral efficiency. The spectral resources are allocated/used as a combination of both time (e.g., slot) and frequency units (e.g., subcarrier). The smallest unit of allocation is termed as a resource block. A resource block spans 12 sub-carriers with a sub-carrier bandwidth of 15 KHz (effective bandwidth of 180 KHz) over a slot duration.

The downlink physical channel corresponds to a set of resource elements carrying information originating from higher layers. A baseband signal representing a downlink physical channel is defined in terms of the following steps: scrambling of coded bits in each of the code words to be transmitted on a physical channel; modulation of scrambled bits to generate complex-valued modulation symbols; mapping of the complex-valued modulation symbols onto one or several transmission layers; precoding of the complex-valued modulation symbols on each layer for transmission on the antenna ports; mapping of complex-valued modulation symbols for each antenna port to resource elements; and generation of complex-valued time-domain OFDM signal for each antenna port.

Additionally, a downlink physical signal corresponds to a set of resource elements used by the physical layer but does not carry information originating from higher layers. The following downlink physical signals are defined: Synchronization signal and Reference signal.

Primary and secondary synchronization signals are transmitted at a fixed subframes (e.g., first and sixth) position in a frame and assists in the cell search and synchronization process at the user terminal. Each cell is assigned unique Primary sync signal.

The reference signal consists of known symbols transmitted at a well defined OFDM symbol position in the slot. This assists the receiver at the user terminal in estimating the channel impulse response to compensate for channel distortion in the received signal. There is one reference signal transmitted per downlink antenna port and an exclusive symbol position is assigned for an antenna port (when one antenna port transmits a reference signal other ports are silent). Reference signals (RS) are used to determine the impulse response of the underlying physical channels.

### SUMMARY OF THE INVENTION

An apparatus for use in a wireless communication network capable of generating a reference signal is provided. The apparatus includes a scrambling sequence generator that is adapted to initialize at the start of a radio frame. The scrambling sequence generator initializes a seed of a scrambling sequence for downlink cell-specific reference signals for Long Term Evolution-Advanced component carriers. The seed is based on the component carrier ID. The apparatus also includes a plurality of transmission antenna that transmits the reference signal.

A wireless communications network with a plurality of base stations is provided. Each one of the base stations is capable of generating a reference signal in a Long Term Evolution-Advanced system. At least one of the base stations includes a scrambling sequence generator that is adapted to initialize at the start of a radio frame. The scrambling sequence generator initializes a seed of a scrambling sequence for downlink cell-specific reference signals for LTE-A component carriers. The seed is based on the component carrier ID. The base station also includes a plurality of transmission antenna adapted to transmit the reference signal.

A method for generating a reference signal in a wireless communications system capable of Long Term Evolution-Advanced communications is provided. The method includes initializing, at the start of a radio frame, a seed of a scrambling sequence for downlink cell-specific reference signals for LTE-A component carriers. The seed is based on the component carrier ID.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (“OFDMA”) wireless network that is capable of decoding data streams according to one embodiment of the present disclosure;

FIG. 2 illustrates an Overview of Physical Channel Processing of an OFDMA transmitter according to an exemplary embodiment of the present disclosure;

FIG. 3 illustrates a Gold Sequence generation diagram according to an exemplary embodiment of the present disclosure;

FIG. 4 illustrates an initialization sequence for a DL Cell-specific Reference Signal according to embodiments of the present disclosure;

FIGS. 5 and 7 illustrate Carrier Aggregation of Three Component Carriers according to embodiments of the present disclosure;

FIG. 6 illustrates a reference signal sequence of one component carrier 510 according to embodiments of the present disclosure;

FIGS. 8 through 11 illustrate an initialization sequence for a DL cell-specific RS according to embodiments of the present disclosure; and

FIGS. 12 and 13 illustrate a reference signal sequence generation for including the reference signal in a mid-guard band according to embodiments of the present disclosure.

### DETAILED DESCRIPTION OF THE INVENTION

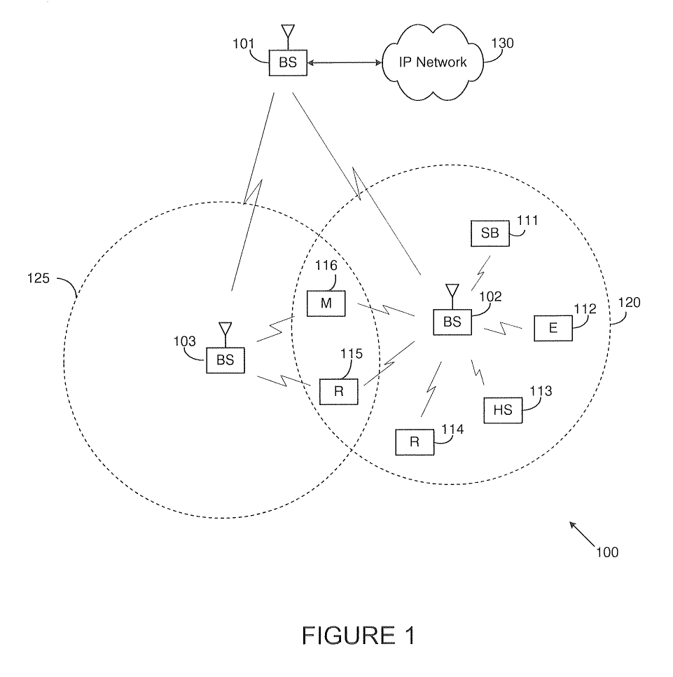

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication network.

It is noted that the term “base station” is used below to refer to infrastructure equipment that is often referred to as “node B” in LTE standards and other literature. Also, the term “subscriber station” is used herein in place of the conventional LTE terms “user equipment” or “UE”. This use of interchangeable terms should not be construed so as to narrow the scope of the claimed invention.

FIG. 1 illustrates exemplary wireless network 100 that transmits reference signals according to principles of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, caf, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random order without being as complex as a receiver that searches all possible decoding orders to find the optimum order.

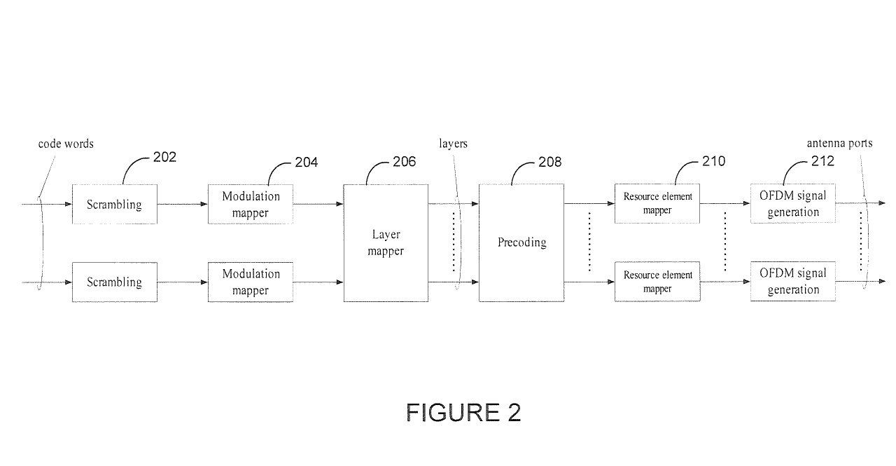

In FIG. 2, the physical downlink processing in an OFDMA transmit path is implemented in base station (BS) 102 for the purposes of illustration and explanation only. However, it should be understood by those skilled in the art that the OFDMA transmit path may also be implemented in SS 116 or in a relay station (not specifically illustrated).

FIG. 2 illustrates an overview of physical channel processing for a general structure for downlink physical channels. It should be understood that this general structure is equally applicable to more than one physical channel.

Scrambling occurs in the scrambling sequence generator 202. For each code word q, the block of bits b^{(q)}(0), . . . , b^{(q)}(M_{bit}^{(q)}−1) where M_{bit}^{(q)} is the number of bits in code word q transmitted on the physical channel in one subframe, shall be scrambled prior to modulation 204, resulting in a block of scrambled bits \tilde{b}^{(q)}(0), . . . , \tilde{b}^{(q)}(M_{bit}^{(q)}−1) according to Equation 1:

\tilde{b}^{q}(i)=(b_{q}(i)+c^{q}(i))mod 2. [Eqn. 1]

In Equation 1, c^{q}(i) is referred to as the pseudo-random scrambling sequence. The scrambling sequence generator 202 is initialized at the start of each subframe.

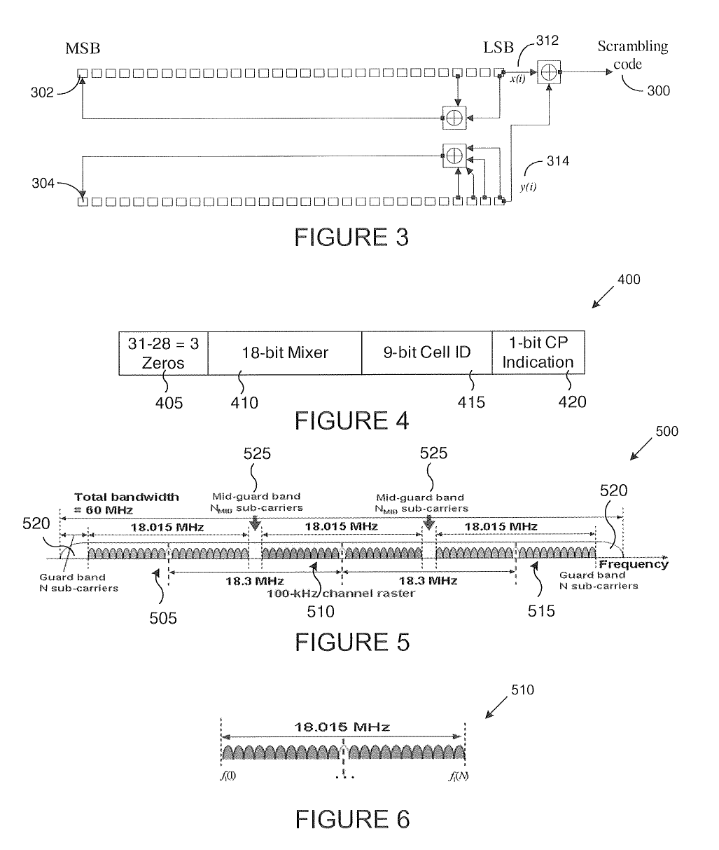

FIG. 3 illustrates a Gold code sequence generation diagram according to embodiments of the present disclosure. The embodiment of the Gold code sequence generation shown in FIG. 3 is for illustration only. Other embodiments could be used without departing from the scope of this disclosure.

In some embodiments, the scrambling sequence generator 202 utilizes Gold codes to generate and initialize scrambling Code 300 sequences. Gold codes are utilized based on feedback polynomial degree L=31 (i.e., length=31) with the following generator polynomials:

1) D³¹+D³+1 for the top register 302, generating the sequence x(i) 312; and

2) D³¹+D³+D²+D+1 for the lower register 304, generating the sequence y(i) 314.

The top register 302 is initialized by filling the top register 302 with the following fixed pattern x(0)=1(MSB), and x(1)= . . . =x(30)=0. The lower register 304 is initialized by filling the lower register 304 with the initialization sequence based on the application of the sequence.

The output of the pseudo-random sequence generation is defined by Equations 2, 3 and 4:

c(n)=(x₁(n+N_{C})+x₂(n+N_{C})mod 2 [Eqn. 2]

x₁(n+31)=(x₁(n+3)+x₁(n))mod 2 [Eqn. 3]

x₂(n+31)=(x₂(n+3)+x₂(n+2)+x₂(n+1)+x₂(n))mod 2 [Eqn. 4]

In Equations 2, 3 and 4, N_{c}=1600.

Reference signals (RS) are used to determine the impulse response of the underlying physical channels. For downlink (DL) cell-specific reference signal, the initialization method for the lower register is shown by Equation 5:

cᵢₙᵢₜ=2¹⁰·(7·(nₛ+1)+z+1)·(2·N_{ID}^{cell}+1)+2·N_{ID}^{cell}+N_{CP} [Eqn. 5]

In Equation 5, n_{S} is the slot number within a radio frame, z is the OFDM symbol number within the slot (it is noted that some forms of this equation use “1” instead of “z”), and N_{ID}^{cell} is the cell ID. N_{CP} is the indication of the extended Cyclic Prefix (CP) or normal cyclic prefix. N_{CP} is defined by Equation 6:

$${N}_{CP} = \{ \begin{matrix}1 & normal & CP \\ 0 & extended & CP .\end{matrix} \qquad [ Eqn . 6 ]$$

Accordingly, in LTE systems, the scrambling sequence is dependent upon the cell ID (e.g., N_{ID}^{cell}). Therefore, since LTE systems do not have multiple component carriers, using the initialization seed for LTE systems produces the same scrambling sequence for the multiple component carriers of the LTE-Advanced (LTE-A) system.

FIG. 4 illustrates an initialization sequence for a DL Cell-specific Reference Signal according to embodiments of the present disclosure. The embodiment of the initialization sequence 400 shown in FIG. 4 is for illustration only. Other embodiments could be used without departing from the scope of this disclosure.

FIG. 4 illustrates the bit fields of the initialization sequence 400 for DL cell-specific reference signal when included in the LTE system. The initialization sequence 400 includes three (3) bits of zeros 405, an eighteen (18) bit mixer 410, a nine (9) bit 415, and a one (1) bit CP indication 420.

The RS sequence generation, r_{z,n}_{_{S}}(m) is defined by Equation 7:

$${r}_{z , {n}_{S}} ( m ) = \frac{1}{\sqrt{2}} ( 1 - 2 \cdot c ( 2 m ) ) + j \frac{1}{\sqrt{2}} ( 1 - 2 \cdot c ( 2 m + ) ) , \\ m = 0 , 1 , … , 2 {N}_{RB}^{max , DL} - 1 \qquad [ Eqn . 7 ]$$

In Equation 7, n_{S} is the slot number within a radio frame and z is the OFDM symbol number within the slot (it is noted that some forms of this equation, and other equations disclosed herein, use “l” instead of “z”). The pseudo-random sequence c(i) is defined in Section 7.2 of 3GPP TS36.211. v 8.4.0. “EUTRA: Physical Channels and Modulation”, the contents of which are hereby incorporated by reference in its entirety. The pseudo-random sequence generator is initialized according to Equation 8 at the start of each OFDM symbol.

cᵢₙᵢₜ=2¹⁰·(7·(n_{S}+1)+z+1)·(2·N_{ID}^{cell}+1)+2·N_{ID}^{cell}N_{CP} [Eqn. 8]

In Equation 8, N_{CP} is defined according to Equation 6 above.

In embodiments of the LTE-A system, spectral bandwidth is much higher than the maximum configuration of the LTE system. Therefore, multiple component carriers, with each following the current LTE numerology, are aggregated together. The bandwidth for the LTE-A system is discussed further in R1-084316 “Summary of email discussion on support for wider bandwidth”, Nokia, RAN1#55, Prague, Czech Republic, November 2008, the contents of which are hereby incorporated by reference in its entirety.

FIG. 5 illustrates Carrier Aggregation of Three Component Carriers according to embodiments of the present disclosure. The embodiment of the carrier aggregation 500 shown in FIG. 5 is for illustration only. Other embodiments could be used without departing from the scope of this disclosure.

Carrier aggregation, where two or more component carriers are aggregated, is utilized in the LTE-A system in order to support downlink transmission bandwidths larger than twenty Megahertz (20 MHz). A terminal, such as MS 116, may simultaneously receive one or multiple component carriers depending on the capabilities of the terminal. For example, when MS 116 is an LTE-A terminal with reception capability beyond 20 MHz, MS 116 can simultaneously receive transmissions on multiple component carriers. When MS 116 is an LTE Release Eight (Rel-8) terminal, MS 116 can receive transmissions on a single component carrier only, provided that the structure of the component carrier follows the Rel-8 specifications.

In FIG. 5, three component carriers 505, 510, 515 are aggregated. Each component carrier 505, 510, 515 is 18.015 MHz. The carrier aggregation 500 has a total bandwidth of 60 MHz. The carrier aggregation 500 includes Guard Band subcarriers 520 and Mid-guard band 525 sub-carriers (e.g. “filler band” or “mid-guard band”).

FIG. 6 illustrates a reference signal sequence of one component carrier 510 according to embodiments of the present disclosure. The embodiment of the reference signal sequence shown in FIG. 6 is for illustration only. Other embodiments could be used without departing from the scope of this disclosure.

Under the conventional framework for supporting wider bandwidths, component carriers of a cell will each have the same cell ID. As shown in pseudo-random Reference Signal Sequence (RSS) generating methods, the final RSS is completely determined by the initial seed of the generating sequence and the initial seed of the generating sequence is completely determined by the slot number within a subframe, OFDM symbol number within a slot and the cell_ID. Therefore, if the cell ID is same for each of the component carriers, using current initialization method, the RRS for each component carrier will be exactly the same since the resource elements for the RS will have the same OFDM symbol number and slot number within a subframe.

Carrier frequencies of different component carriers should be different as multiples of 300 KHz raster to facilitate a single FFT operation across all the component carriers. In such case, the reference sequences input to the FFT across all the subcarriers are a periodic extension of a base sequence. For example, the reference sequence 600 generated for component carrier 510, can be illustrated as shown in FIG. 6.

In FIG. 6, f₁(1), . . . , f₁(N) is the generated RSS for component carrier 515.

For the other two component carriers 505, 520, the RSS will generated based on the conventional initialization method will be exactly the same as for component carrier 515.

Therefore, the same RSS f₁(1), . . . , f₁(N) will be generated for each component carrier 505, 510, 515 and the total RSS of the carriers input into the single IFFT will be f₁(1), . . . , f₁(N), f₁(1), . . . f₁(N), f₁(1), . . . , f₁(N) that is a periodic extension of f₁(1), . . . , f₁(N).

Due to the properties of IFFT and the fact the total RSS is a periodic sequence, the output sequence of IFFT will have the following property: out of three consecutive symbols only one will be nonzero while the other two are strictly zero. This result will hold for the case where M component carriers are aggregated together. That is, the output sequence of IFFT will have the following property: one symbol of M consecutive symbols is nonzero while the other M−1 symbols are strictly zero. This will cause extremely high Peak-to-Average Power Ratio (PAPR) due to the multiple zeros in the downlink signals.

Embodiments of this disclosure reduce the PAPR by breaking a periodicity of the overall RRS input to the IFFT at the transmit side. In some embodiments, different initialization seeds are generated for component carriers for an LTE-A user only. Since some component carriers for LTE-A user exist only to perform advanced operations such as Coordinated Multipoint (COMP) transmission, a new initialization method for RSS can be designed for the LTE-A component carrier to break the periodicity across all the component carriers. By doing this, the PAPR problem of the transmitted signal will be mitigated.

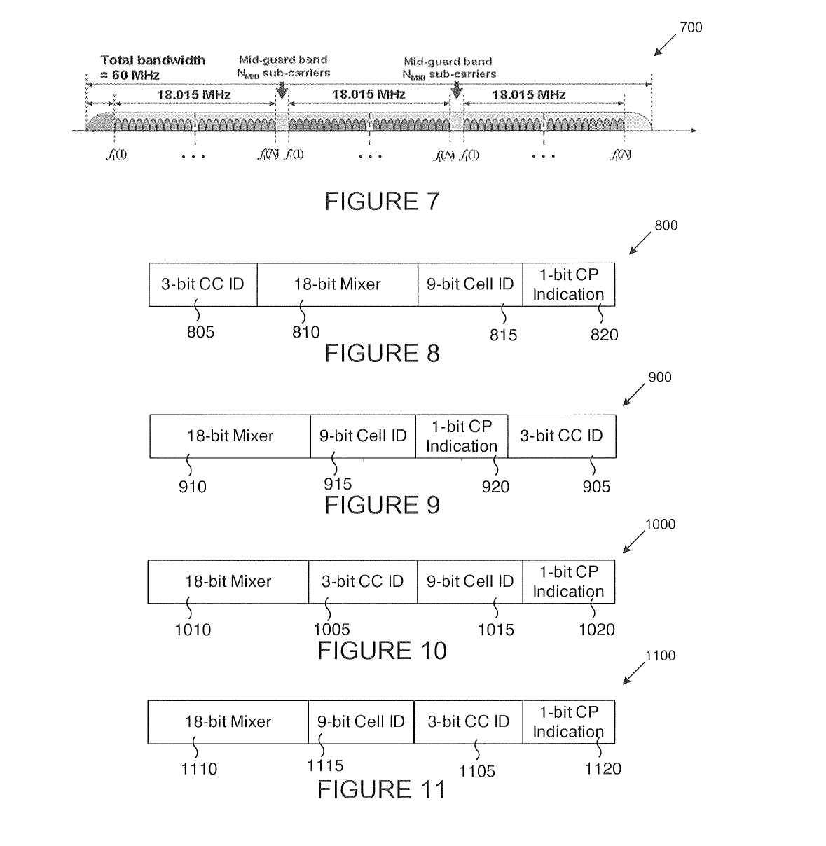

In additional and alternative embodiments, the RS transmitted over the “mid-guard band” 525 is designed to be aperiodic in order to break the periodicity of the overall RSS. A certain amount of carriers exists between component carriers to guarantee the multiple of 300 KHz separation between carrier frequencies. The illustration of the “filler band,” or “mid-guard band” 525, can be seen more clearly in FIG. 7. Under this configuration, the “filler bands” or “mid-guard bands” 525 are used to break the periodicity of the RSS. By having aperiodic RSSs over filler bands, the overall the RSS over the entire bandwidth become aperiodic and the PAPR is reduced.

FIG. 8 illustrates an initialization sequence for a DL cell-specific RS according to embodiments of the present disclosure. The embodiment of the initialization sequence 800 shown in FIG. 8 is for illustration only. Other embodiments could be used without departing from the scope of this disclosure.

The initialization sequence for LTE systems utilizes twenty-eight (28) bits as illustrated in FIG. 4 (e.g., initialization sequence 400 includes three bits of zeros 405). In some embodiments, the initialization seed cᵢₙᵢₜ of the scrambling sequence generation for downlink cell-specific reference signals for the LTE-A component carriers is changed. The new initialization seed, cᵢₙᵢₜ, for the LTE-A component carriers depends on the component carrier (N_{ID}^{CC}). The component carrier ID is inserted into the initialization sequence 800. Therefore, in some embodiments, the initialization sequence 800 for LTE-A systems includes thirty-one (31) bits as opposed to twenty-eight (28) bits (e.g., twenty-eight non-zero bits used) for the LTE system.

For example, the pseudo-random sequence generator (e.g., in scrambling block 202) is initialized with Equation 9:

cᵢₙᵢₜ=2²⁸·N_{ID}^{CC}+2¹⁰·(7·(n_{S}+1)+z+1)·(2·N_{ID}^{cell}+1)+2·N_{ID}^{cell}+N_{CP} [Eqn. 9]

The first three bits are used to indicate the component carrier ID 805 within the aggregated component carriers. This configuration can be used to support up to 8 aggregated component carriers. The initialization sequence 800 also includes an 18-bit Mixer 810 and 9-bit cell ID 815 and a 1-bit CP indication 820. The “18-bit Mixer” 810 represents the total 18 bits constructed by Equation 10:

18-bit Mixer=(7·(nₛ+1)+z+1)·(2·N_{ID}^{cell}+1). [Eqn. 10]

FIG. 9 illustrates another initialization sequence for a DL cell-specific RS according to embodiments of the present disclosure. The embodiment of the initialization sequence 900 shown in FIG. 9 is for illustration only. Other embodiments could be used without departing from the scope of this disclosure.

In some embodiments, the pseudo-random sequence generator shall be initialized using Equation 11:

cᵢₙᵢₜ=+2¹³·(7·(n_{S}+1)+z+1)·(2·N_{ID}^{cell}+1)+2⁴·N_{ID}^{cell}+2³·N_{CP}+N_{ID}^{CC} [Eqn. 11]

The last three bits are used to indicate the component carrier ID 905 within the aggregated component carriers. The initialization sequence 900 also includes an 18-bit Mixer 910 and 9-bit cell ID 915 and a 1-bit CP indication 920. The “18-bit Mixer” 910 represents the total 18 bits constructed by Equation 10, above.

FIG. 10 illustrates another initialization sequence for a DL cell-specific RS according to embodiments of the present disclosure. The embodiment of the initialization sequence 1000 shown in FIG. 10 is for illustration only. Other embodiments could be used without departing from the scope of this disclosure.

In some embodiments, the pseudo-random sequence generator shall be initialized using Equation 12:

cᵢₙᵢₜ=2¹³·(7·(n_{S}+1)+z+1)·(2·N_{ID}^{cell}+1)+2¹⁰·N_{ID}^{CC}+2·N_{ID}^{cell}+N_{CP}. [Eqn. 12]

The three bits after the 18-bit Mixer 1010 are used to indicate the component carrier ID 1005 within the aggregated component carriers. This configuration can be used to support up to eight (8) aggregated component carriers. The initialization sequence 1000 also includes a 9-bit cell ID 1015 and a 1-bit CP indication 1020. The “18-bit Mixer” 1010 represents the total 18 bits constructed by Equation 10, above.

FIG. 11 illustrates another initialization sequence for a DL cell-specific RS according to embodiments of the present disclosure. The embodiment of the initialization sequence 1100 shown in FIG. 11 is for illustration only. Other embodiments could be used without departing from the scope of this disclosure.

In some embodiments, the pseudo-random sequence generator shall be initialized using Equation 13:

cᵢₙᵢₜ=2¹³·(7·(n_{S}+1)+z+1)·(2·N_{ID}^{cell}+1)+2⁴·N_{ID}^{cell}+2·N_{ID}^{CC}+N_{CP}. [Eqn. 13]

The component carrier ID 1105 is indicated by three bits occurring after the 9-bit cell ID 1115. This configuration can be used to support up to eight (8) aggregated component carriers. The initialization sequence 1100 also includes an 18-bit Mixer 1110 and a 1-bit CP indication 1120. The “18-bit Mixer” 1110 represents the total 18 bits constructed by Equation 10, above.

In some embodiments, the initialization sequence for LTE-A systems uses twenty-eight (28) bits. However, in such embodiments, the initialization seed cᵢₙᵢₜ of the scrambling sequence generation for downlink cell-specific reference signals for the LTE-A only component carrier is changed based on the component carrier ID. The initialization seed is changed by altering the 18-bit Mixer (e.g., 18-bit Mixer 405 for the 28-bit initialization sequence 400 in FIG. 4) based on the component ID. In particular, the initialization seed cᵢₙᵢₜ is constructed for downlink cell-specific reference signal for LTE-A component carriers based on Equation 14A:

cᵢₙᵢₜ=2¹⁰·(7·(nₛ+1)+z+1)·(2·mod(N_{ID}^{cell}+N_{ID}^{CC},504)+1)+2·N_{ID}^{cell}+N_{CP} [Eqn. 14A]

In Equation 14, n_{S} is the sub-frame number and N_{ID}^{CC} is the component carrier ID. Accordingly, the 18-bit Mixer (e.g., 18-bit Mixer 405) is defined by Equation 14B:

18-bit mixer=(7·(n_{S}+1)+z+1)·(2·mod(N_{ID}^{cell}+N_{ID}^{CC},504)+1). [Eqn. 14B]

In some embodiments, the initialization seed cᵢₙᵢₜ is constructed for downlink cell-specific reference signal for LTE-A component carriers based on Equation 15A:

cᵢₙᵢₜ=2¹⁰·(7·(mod(n_{S}+N_{ID}^{CC},20)+1)+z+1)·(2·N_{ID}^{cell}+1)+2·N_{ID}^{cell}+N_{CP} [Eqn. 15A]

In Equation 15A, N_{ID}^{CC} is the component carrier ID. Accordingly, the 18-bit Mixer (e.g., 18-bit Mixer 405) is defined by Equation 15B:

18-bit Mixer=(7·(mod(n_{S}+N_{ID}^{CC},20)+1)+z+1)·(2·N_{ID}^{cell}+1). [Eqn. 15B]

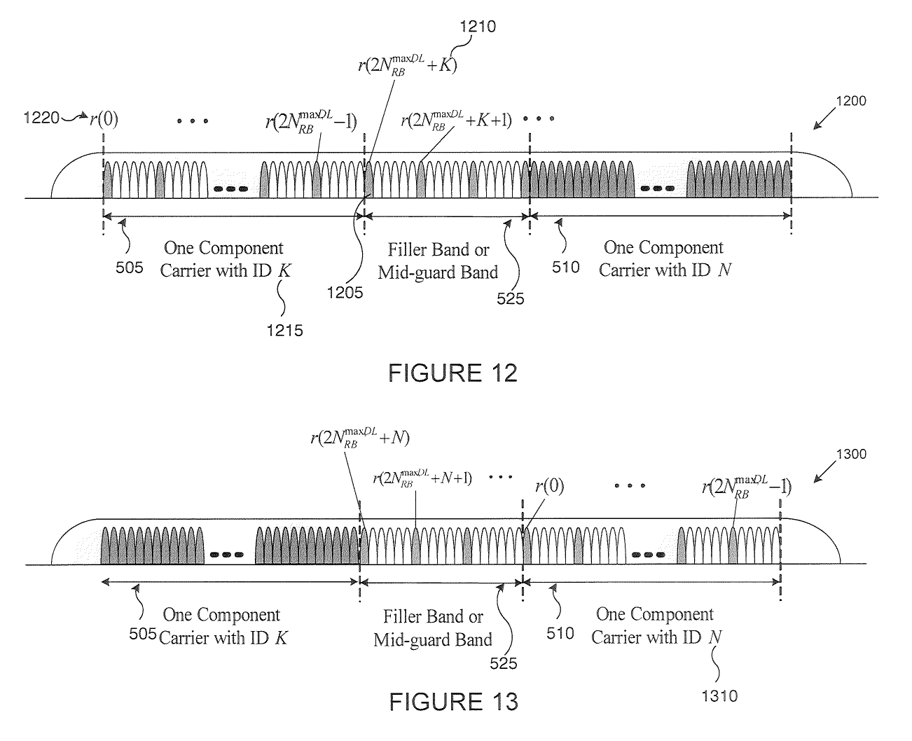

FIG. 12 illustrates a reference signal sequence generation for including the reference signal in a mid-guard band according to embodiments of the present disclosure. The embodiment of the RSS generation 1200 shown in FIG. 12 is for illustration only. Other embodiments could be used without departing from the scope of this disclosure.

In some embodiments, cell-specific reference signals are included in mid-guard band 525 (e.g., filler band) between component carriers. The RSS 1205 of the mid-guard band 525 is extended from the reference signal sequence of the nearby component carrier 505 with an offset 1210 depending on the component carrier ID 1215 of the nearby component carrier.

For example, the RSS 1205, z_{z,n}_{_{S}}(m), of the mid-guard band 525 can be defined by Equation 16:

$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 2 {N}_{RB}^{max , DL} + k {N}_{ID}^{CC} + c , 2 {N}_{RB}^{max , DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 \qquad [ Eqn . 16 ]$$

In Equation 16, n_{S} is the slot number within a radio frame, z is the OFDM symbol number within the slot(it is noted that some forms of this equation use “l” instead of “z”) and N_{ID}^{CC} is the component carrier ID of the preceding component carrier. Further, k can be any positive integer value and C can be any non-negative integer value. For example, FIG. 12 illustrates a RSS for any nₛ and z pair in the case where k=1 and c=0. Additionally, r(0) through r(2N_{RB}^{max,DL}+k) 1220 are the reference symbols used for the component carrier 505.

FIG. 13 illustrates another reference signal sequence generation for including the reference signal in a mid-guard band according to embodiments of the present disclosure. The embodiment of the RSS generation 1300 shown in FIG. 13 is for illustration only. Other embodiments could be used without departing from the scope of this disclosure.

In an additional example, for any nₛ and z pair in the case where k=1 and c=0, illustrated in FIG. 13, the RSS 1305, r_{z,n}_{ₛ}(m)f of the mid-guard band 525 (e.g., filler band) is defined by Equation 17:

$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 2 {N}_{RB}^{max , DL} + k {N}_{ID}^{CC} + c , 2 {N}_{RB}^{max , DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 \qquad [ Eqn . 17 ]$$

In Equation 17, nₛ is the slot number within a radio frame, z is the OFDM symbol number within the slot (it is noted that some forms of this equation use “1” instead of “z”) and N_{ID}^{CC} is the component carrier ID 1310 of the following component carrier 510. Further, k can be any positive integer value and C can be any non-negative integer value.

In yet another example, the RSS, r_{z,n}_{ₛ}(m), of the filler band or mid-guard band is defined by Equation 18:

$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = {N}_{RB}^{max , DL} + {N}_{RB}^{DL} + k {N}_{ID}^{CC} + c , {N}_{RB}^{max , DL} + {N}_{RB}^{DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 \qquad [ Eqn . 18 ]$$

In Equation 18, nₛ is the slot number within a radio frame, z is the OFDM symbol number within the slot, N_{RB}^{DL} is the number of Physical Resource Blocks (PRBs) of the preceding component carrier and N_{ID}^{CC} is the component carrier ID of the preceding component carrier. Further, k can be any positive integer value and c can be any non-negative integer value.

In yet still another example, the RSS, r_{z,n}_{ₛ}(m), of the filler band or mid-guard band is defined by Equation 19:

$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = {N}_{RB}^{max , DL} + {N}_{RB}^{DL} + k {N}_{ID}^{CC} + c , {N}_{RB}^{max , DL} + {N}_{RB}^{DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 \qquad [ Eqn . 19 ]$$

In Equation 19, n_{S} is the slot number within a radio frame, z is the OFDM symbol number within the slot (it is noted that some forms of this equation use “1” instead of “z”), N_{RB}^{DL} is the number of PRBs of the following component carrier and N_{ID}^{CC} is the component carrier ID of the following component carrier. Further, k can be any positive integer value and c can be any non-negative integer value.

In some embodiments, cell-specific reference signals are included in the filler band or mid-guard band between component carriers. The reference signal sequence of the filler band or mid-guard band is extended from the reference signal sequence of the nearby component carrier continuously.

For example, the r_{z,n}_{_{S}}(m) of the component carrier including the following filler band or mid-guard band is defined by Equation 20:

$${r}_{z , {n}_{s}} ( m ) = \frac{1}{\sqrt{2}} ( 1 - 2 \cdot c ( 2 m ) ) + j \frac{1}{\sqrt{2}} ( \begin{matrix}1 - 2 \cdot \\ c ( 2 m + 1 )\end{matrix} ) , \\ m = 0 , 1 , … 2 ( {N}_{RB}^{max , DL} + ⌈ \frac{{N}_{additional \_ sub c}}{12} ⌉ ) - 1 \qquad [ Eqn . 20 ]$$

In Equation 20, n_{S} is the slot number within a radio frame, z is the OFDM symbol number within the slot (it is noted that some forms of this equation use “l” instead of “z”) and N_{additional}_{_{—}}_{subc} is bandwidth of the filler band or mid-guard band in terms of number of subcarriers. The reference signal sequence r_{z,n}_{_{S}}(111) shall be mapped to complex-valued modulation symbols a_{k,z}^{(p)} used as reference symbols for antenna port p in slot nₛ according to Equation 21:

$$\begin{matrix}{a}_{k , z}^{( p )} = {r}_{z , {n}_{s}} ( {m}^{′} ) & [ Eqn . 21 ] \\ Where & \\ k = 6 m + ( v + {v}_{shift} ) mod 6 \\ z = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot ( {N}_{RB}^{DL} + ⌈ \frac{{N}_{additional \_ subc}}{12} ⌉ ) - 1 \\ {m}^{′} = m + {N}_{RB}^{max , DL} - {N}_{RB}^{DL} & [ Eqn . 22 ]\end{matrix}$$

The variables v and v_{shift} define the position in the frequency domain for the different reference signals where v is defined by Equation 23:

$$v = \{ \begin{matrix}0 & if p = 0 and z = 0 \\ 3 & if p = 0 and z \neq 0 \\ 3 & if p = 1 and z = 0 \\ 0 & if p = 1 and z \neq 0 \\ 3 ( {n}_{s} mod 2 ) & if p = 2 \\ 3 + 3 ( {n}_{s} mod 2 ) & if p = 3\end{matrix} \qquad [ Eqn . 23 ]$$

The cell-specific frequency shift is defined by Equation 24:

v_{shift}=N_{ID}^{cell} mod 6. [Eqn. 24]

In some embodiments, the reference signal sequences of the filler bands or mid-guard bands between component carriers are different portions of a single pseudo random sequence.

For example, the RSS, r_{z,n}_{_{S}}(m), of the first filler band or mid-guard band is defined by Equation 25:

$${r}_{z , {n}_{s}} ( m ) = \frac{1}{\sqrt{2}} ( 1 - 2 \cdot c ( 2 m ) ) + j \frac{1}{\sqrt{2}} ( \begin{matrix}1 - 2 \cdot \\ c ( 2 m + 1 )\end{matrix} ) , \\ m = 0 , 1 , … , 2 ⌈ \frac{{N}_{additional \_ subc 1}}{12} ⌉ - 1 \qquad [ Eqn . 25 ]$$

In Equation 25, n_{S} is the slot number within a radio frame, z is the OFDM symbol number within the slot and N_{additional}_{_{—}}_{subc1} is bandwidth of the first filler band or mid-guard band in terms of number of subcarriers. While r_{z,n}_{_{S}}(m) of the second filler band or mid-guard band is defined by Equation 26:

$${r}_{z , {n}_{s}} ( m ) = \frac{1}{\sqrt{2}} ( 1 - 2 \cdot c ( 2 m ) ) + j \frac{1}{\sqrt{2}} ( \begin{matrix}1 - 2 \cdot \\ c ( 2 m + 1 )\end{matrix} ) , \\ m = 2 ⌈ \frac{{N}_{additional \_ subc 1}}{12} ⌉ , \\ 2 ⌈ \frac{{N}_{additional \_ subc 1}}{12} ⌉ + 1 , … , \\ 2 ⌈ \frac{{N}_{additional \_ subc 1}}{12} ⌉ + 2 ⌈ \frac{{N}_{additional \_ subc 2}}{12} ⌉ - 1 \qquad [ Eqn . 26 ]$$

In Equation 26, N_{additional}_{_{—}}_{subc2} is bandwidth of the second filler band or mid-guard band in terms of number of subcarriers.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for use in a MIMO wireless communication network capable of generating a reference signal, the apparatus comprising:
a scrambling sequence generator adapted to initialize at the start of a radio sub-frame, the scrambling sequence generator configured to initialize a seed of a scrambling sequence for downlink cell-specific reference signals for component carriers, wherein the seed is based on the component carrier ID; and
a plurality of transmission antenna adapted to transmit the reference signal.

2. The apparatus as set forth in claim 1, wherein the seed of the scrambling sequence comprises thirty-one bits, wherein at least three of the bits comprise the component carrier ID.

3. The apparatus as set forth in claim 2, wherein the seed is generated using one of four equations, the first equation defined as:
cᵢₙᵢₜ=2²⁸·N_{ID}^{CC}+2¹⁰·(7·(n_{S}+1)+z+1)·(2·N_{ID}^{cell}+1)+2·N_{ID}^{cell}+N_{CP};
the second equation defined as:
cᵢₙᵢₜ=2¹³·(7·(n_{S}+1)+z+1)·(2·N_{ID}^{cell}+1)+2⁴·N_{ID}^{cell}+2³·N_{CP}+N_{ID}^{CC};
the third equation defined as:
cᵢₙᵢₜ=2¹³·(7·(n_{S}+1)+z+1)·(2·N_{ID}^{cell}+1)+2¹⁰·N_{ID}^{CC}+2·N_{ID}^{cell}+N_{CP};
and
the fourth equation defined as:
cᵢₙᵢₜ=2¹³·(7·(n_{S}+1)+z+1)·(2·N_{ID}^{cell}+1)+2⁴·N_{ID}^{cell}+2·N_{ID}^{CC}+N_{CP};
wherein cᵢₙᵢₜ is the seed, n_{S} is a slot number within a radio frame, z is an OFDM symbol number with the slot, N_{ID}^{cell} is a cell identifier, N_{ID}^{CC} is the component carrier identifier, and N_{CP} is an indicator of one of: a Cyclic Prefix (CP) and an extended CP.

4. The apparatus as set forth in claim 1, wherein the seed of the scrambling sequence comprises at least twenty-eight bits, wherein the twenty-eight bits include an 18-bit mixer, wherein the 18-bit mixer comprises a block of eighteen bits constructed using the component carrier ID, and wherein the seed is defined by:
cᵢₙᵢₜ=2¹⁰·(18-bit mixer)+2·N_{ID}^{cell}+2·N_{ID}^{cell}+N_{CP}.

5. The apparatus as set forth in claim 4, wherein the 18-bit mixer is constructed using at least one of two equations,
the first equation defined as:
18-bit Mixer=(7·(nₛ+1)+z+1)·(2·mod(N_{ID}^{cell}N_{ID}^{CC},504)+1);
and
the second equation defined as:
18-bit Mixer=(7·(mod(n_{S}+N_{ID}^{CC},20)+1)+z+1)·(2·N_{ID}^{cell}+1);
wherein n_{S} is a slot number within a radio frame, z is an OFDM symbol number with the slot, N_{ID}^{cell} is a cell identifier, and N_{ID}^{CC} is the component carrier identifier.

6. An apparatus for use in a wireless communication network capable of generating a reference signal, the apparatus comprising:
a reference signal generator adapted to generate the reference signal, wherein the reference signal is included in a filler bands between at least two consecutive component carriers; and
a plurality of transmission antenna adapted to transmit the reference signal.

7. The apparatus as set forth in claim 6, wherein the reference signal is extended from a reference signal sequence of one of the at least two component carriers.

8. The apparatus as set forth in claim 6, wherein the reference signal is defined by:
$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , ,$$
and wherein m is defined by at least one of:
$$m = 2 {N}_{RB}^{max , DL} + k {N}_{ID}^{CC} + c , 2 {N}_{RB}^{max , DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 ; \\ m = {N}_{RB}^{max , DL} + {N}_{RB}^{DL} + k {N}_{ID}^{CC} + c , {N}_{RB}^{max , DL} + {N}_{RB}^{DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 ; \\ m = 0 , 1 , … 2 ( {N}_{RB}^{max , DL} + ⌈ \frac{{N}_{additional \_ subc}}{12} ⌉ ) - 1 ; \\ m = 0 , 1 , … , 2 ⌈ \frac{{N}_{additional \_ subc 1}}{12} ⌉ - 1 ; and \\ m = 2 ⌈ \frac{{N}_{additional \_ subc 1}}{12} ⌉ , \\ 2 ⌈ \frac{{N}_{additional \_ subc 1}}{12} ⌉ + 1 , … , \\ 2 ⌈ \frac{{N}_{additional \_ subc 1}}{12} ⌉ + 2 ⌈ \frac{{N}_{additional \_ subc 2}}{12} ⌉ - 1 ;$$
wherein n_{S} is a slot number within a radio frame, z is a OFDM symbol number within the slot, N_{RB}^{DL} is a number of Physical Resource Blocks (PRBs) of the preceding component carrier, N_{ID}^{CC} is a component carrier identifier of a preceding component carrier, k a positive integer value, C is a non-negative integer value, N_{additional}_{_{—}}_{subc} is a bandwidth of the filler band in terms of number of subcarriers, and N_{additional}_{_{—}}_{subc2} is a bandwidth of a second filler band in terms of number of subcarriers.

9. For use in a wireless communications network comprising a plurality of base stations capable of communicating with a plurality of subscriber stations, each one of the base stations capable of generating a reference signal in a system, at least one of the subscriber stations comprising:
a receiver configured to receive a scrambling sequence initialized at the start of a radio sub-frame, wherein the a seed of a scrambling sequence is initialized for downlink cell-specific reference signals for component carriers, and wherein the seed is based on the component carrier ID.

10. The subscriber station as set forth in claim 9, wherein the scrambling sequence comprises thirty-one bits, and wherein at least three of the bits comprise the component carrier ID.

11. The subscriber station as set forth in claim 10, wherein the seed is generated using one of four equations, the first equation defined as:
cᵢₙᵢₜ=2²⁸·N_{ID}^{CC}+2¹⁰·(7·(nₛ+1)+z+1)·(2·N_{ID}^{cell}+1)+(2·N_{ID}^{cell}+N_{CP};
the second equation defined as:
cᵢₙᵢₜ2¹³·(7·(nₛ+1)+z+1)·(2·N_{ID}^{cell}+1)+2⁴·N_{ID}^{cell}2³N_{CP}+N_{ID}^{CC};
the third equation defined as:
cᵢₙᵢₜ=2¹³·(7·(nₛ+1)+z+1)·(2·N_{ID}^{cell}+1)+2¹⁰·N_{ID}^{CC}+2·N_{ID}^{cell}+N_{CP};
and
the fourth equation defined as:
cᵢₙᵢₜ=2¹³·(7·(nₛ+1)+z+1)·(2·N_{ID}^{cell}+1)+2⁴·N_{ID}^{cell}+2·N_{ID}^{CC}+N_{CP};
wherein cᵢₙᵢₜ is the seed, nₛ is a slot number within a radio frame, z is an OFDM symbol number with the slot, N_{ID}^{cell} is a cell identifier, N_{ID}^{CC} is the component carrier identifier, and N_{CP} is an indicator of one of: a Cyclic Prefix (CP) and an extended CP.

12. The subscriber station as set forth in claim 9, wherein the scrambling sequence comprises at least twenty-eight bits, wherein the twenty-eight bits include an 18-bit Mixer, wherein the 18-bit mixer comprises a block of eighteen bits constructed using the component carrier ID, and wherein the seed is defined by:
cᵢₙᵢₜ=2¹⁰·(18-bit mixer)+2·N_{ID}^{cell}+2·N_{ID}^{cell}+N_{CP}.

13. The subscriber station as set forth in claim 12, wherein the 18-bit mixer is constructed using at least one of two equations,
the first equation defined as:
18-bit Mixer=(7·(n_{S}+1)+z+1)·(2·mod(N_{ID}^{cell}+N_{ID}^{CC},504)+1);
and
the second equation defined as:
18-bit Mixer=(7·(mod(n_{S}+N_{ID}^{CC},20)+1)+z+1)·(2·N_{ID}^{cell}+1);
wherein nₛ is a slot number within a radio frame, z is an OFDM symbol number with the slot, N_{ID}^{cell} is a cell identifier, and N_{ID}^{CC} is the component carrier identifier.

14. For use in a wireless communications network comprising a plurality of base stations capable of communicating with a plurality of subscriber stations, each one of the base stations capable of generating a reference signal in a system, at least one of the subscriber stations comprising:
a receiver configured to receive a reference signal from at least one base station, wherein the reference signal is included in a filler bands between at least two component carriers.

15. The subscriber station as set forth in claim 14, wherein the reference signal is extended from a reference signal sequence of one of the at least two component carriers.

16. The subscriber station as set forth in claim 14, wherein the reference signal is defined by:
$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , ,$$
and wherein m is defined by at least one of:
$$m = 2 {N}_{RB}^{max , DL} + k {N}_{ID}^{CC} + c , 2 {N}_{RB}^{max , DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 ; \\ m = {N}_{RB}^{max , DL} + {N}_{RB}^{DL} + k {N}_{ID}^{CC} + c , {N}_{RB}^{max , DL} + {N}_{RB}^{DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 ; \\ m = 0 , 1 , … 2 ( {N}_{RB}^{max , DL} + ⌈ \frac{{N}_{additional \_ subc}}{12} ⌉ ) - 1 ; \\ m = 0 , 1 , … , 2 ⌈ \frac{{N}_{additional \_ subc 1}}{12} ⌉ - 1 ; and \\ m = 2 ⌈ \frac{{N}_{additional \_ subc 1}}{12} ⌉ , \\ 2 ⌈ \frac{{N}_{additional \_ subc 1}}{12} ⌉ + 1 , … , \\ 2 ⌈ \frac{{N}_{additional \_ subc 1}}{12} ⌉ + 2 ⌈ \frac{{N}_{additional \_ subc 2}}{12} ⌉ - 1 ;$$
wherein n_{S} is a slot number within a radio frame, z is a OFDM symbol number within the slot, N_{RB}^{DL} is a number of Physical Resource Blocks (PRBs) of the preceding component carrier, N_{ID}^{CC} is a component carrier identifier of a preceding component carrier, k a positive integer value, c is a non-negative integer value, N_{additional}_{_{—}}_{subc} is a bandwidth of the filler band in terms of number of subcarriers, and N_{additional}_{_{—}}_{subc2} is a bandwidth of a second filler band in terms of number of subcarriers.

17. For use in a wireless communications system capable of communications, a method of generating a reference signal, the method comprising:
initializing, at the start of a radio sub-frame, a seed of a scrambling sequence for downlink cell-specific reference signals for component carriers, wherein the seed is based on the component carrier ID.

18. The method as set forth in claim 17, wherein the seed of the scrambling sequence comprises thirty-one bits, wherein at least three of the bits comprise the component carrier ID.

19. The method as set forth in claim 18, wherein initializing the scrambling sequence further comprises: generating the seed using one of four equations, the first equation defined as:
cᵢₙᵢₜ=2²⁸·N_{ID}^{CC}+2¹⁰·(7·(nₛ+1)+z+1)·(2·N_{ID}^{cell}+1)+2·N_{ID}^{cell}+N_{CP};
the second equation defined as:
cᵢₙᵢₜ=2¹³·(7·(nₛ+1)+z+1)·(2·N_{ID}^{cell}+1)+2⁴·N_{ID}^{cell}+2³·N_{CP}+N_{ID}^{CC};
the third equation defined as:
cᵢₙᵢₜ=2¹³·(7·(n_{S}+1)+z+1)·(2·N_{ID}^{cell}+1)+2¹⁰·N_{ID}^{CC}+2·N_{ID}^{cell}+N_{CP};
and
the fourth equation defined as:
cᵢₙᵢₜ=2¹³·(7·(n_{S}+1)+z+1)·(2·N_{ID}^{cell}+1)+2⁴·N_{ID}^{cell}+2·N_{ID}^{CC}+N_{CP};
wherein cᵢₙᵢₜ is the seed, nₛ is a slot number within a radio frame, z is an OFDM symbol number with the slot, N_{ID}^{cell} is a cell identifier, N_{ID}^{CC} is the component carrier identifier, and N_{CP} is an indicator of one of: a Cyclic Prefix (CP) and an extended CP.

20. The method as set forth in claim 17, wherein the seed of the scrambling sequence comprises at least twenty-eight bits, wherein the twenty-eight bits include an 18-bit mixer, wherein the 18-bit mixer comprises a block of eighteen bits constructed using the component carrier ID, and wherein the seed is defined by:
cᵢₙᵢₜ=2¹⁰·(18-bit mixer)+2·N_{ID}^{cell}+2·N_{ID}^{cell}+N_{CP}.

21. The method as set forth in claim 20, wherein generating further comprises constructing the 18-bit Mixer using at least one of two equations,
the first equation defined as:
18-bit Mixer=(7·(nₛ+1)+z+1)·(2·mod(N_{ID}^{cell}+N_{ID}^{CC},504)+1);
and
the second equation defined as:
18-bit Mixer=(7·(mod(nₛ+N_{ID}^{CC},20)+1)+z+1)·(2·N_{ID}^{cell}+1);
wherein nₛ is a slot number within a radio frame, z is an OFDM symbol number with the slot, N_{ID}^{cell} is a cell identifier, and N_{ID}^{CC} is the component carrier identifier.

22. A method for transmitting a reference signal, the method comprising:
initializing the reference signal; and
transmitting the reference signal in a filler band between at least two component carriers.

23. The method as set forth in claim 22, wherein transmitting further comprises extending a reference signal sequence of the at least two component carriers.

24. The method as set forth in claim 22, wherein initializing further comprises generating the reference signal using one of four equation sets,
the first equation set defined by:
$${r}_{z , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , ,$$
and wherein m is defined by at least one of:
$$m = 2 {N}_{RB}^{max , DL} + k {N}_{ID}^{CC} + c , 2 {N}_{RB}^{max , DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 ; \\ m = {N}_{RB}^{max , DL} + {N}_{RB}^{DL} + k {N}_{ID}^{CC} + c , {N}_{RB}^{max , DL} + {N}_{RB}^{DL} + k {N}_{ID}^{CC} + c + 1 , … , {N}_{RB}^{max , DL} + {N}_{RB}^{DL} + k {N}_{ID}^{CC} + c + 2 [ \frac{{N}_{additional \_ sub 1}}{12} ] - 1 ; \\ m = 0 , 1 , … 2 ( {N}_{RB}^{max , DL} + ⌈ \frac{{N}_{additional \_ subc}}{12} ⌉ ) - 1 ; \\ m = 0 , 1 , … , 2 ⌈ \frac{{N}_{additional \_ subc 1}}{12} ⌉ - 1 ; and \\ m = 2 ⌈ \frac{{N}_{additional \_ subc 1}}{12} ⌉ , \\ 2 ⌈ \frac{{N}_{additional \_ subc 1}}{12} ⌉ + 1 , … , \\ 2 ⌈ \frac{{N}_{additional \_ subc 1}}{12} ⌉ + 2 ⌈ \frac{{N}_{additional \_ subc 2}}{12} ⌉ - 1 ;$$
wherein n_{S} is a slot number within a radio frame, z is a OFDM symbol number within the slot, N_{RB}^{DL} is a number of Physical Resource Blocks (PRBs) of the preceding component carrier, N_{ID}^{CC} is a component carrier identifier of a preceding component carrier, k a positive integer value, C is a non-negative integer value, N_{additional}_{_{—}}_{subc} is a bandwidth of the filler band in terms of number of subcarriers, and N_{additional}_{_{—}}_{subc2} is a bandwidth of a second filler band in terms of number of subcarriers.
